(19) United States
(12) Patent Application Publication
(10) Pub. No.: US 2010/0194700 A1
(43) Pub. Date: Aug. 5, 2010

(54) CHARACTER INPUT DEVICE

(76) Inventor: Eui Jin Oh, Daejeon (KR)

Correspondence Address: LEXYOUME IP GROUP, LLC, 5180 PARKSTONE DRIVE, SUITE 175, CHANTILLY, VA, 20151, US

(21) Appl. No.: 12/595,852

(22) PCT Filed: Apr. 24, 2008
(86) PCT No.: PCT/KR2008/002344

§ 371 Date: Oct. 14, 2009

(30) Foreign Application Priority Data
Apr. 24, 2007 (KR) 1020070039789

(51) Int. Cl. G06F 3/041

(52) U.S. Cl. 345/173

(57) ABSTRACT

The present invention relates to a character input device which allows all the characters which it is desired to input to be arranged in a minimum input region so as to be suitable for miniaturization, as well as allows each of the arranged characters to be input through only one-input operation so as to enable rapid and correct input of a character. The character input device includes a base having an input region; one or more sensing sections provided at the input region for sensing a contact with the input region or a contact movement to the input region; and a control unit for extracting data corresponding to each input operation from a memory unit (not shown) and inputting the extracted data, according to the position of a contact point or the movement direction of the contact point sensed by the sensing section relative to a reference input section provided at the input region.

### TECHNICAL FIELD

The present invention relates to a character input device, and more particularly, to a character input device which allows all the characters which it is desired to input to be arranged in a minimum input region so as to be suitable for miniaturization, as well as allows each of the arranged characters to be input through only one-input operation.

### BACKGROUND ART

With the development of software and semiconductor technology and information processing technology, information equipment is miniaturized gradually, and the amount of characters input to such information equipment and its importance are increasing.

However, such information equipment causes a lot of problems when various characters and commands are input thereto. For example, an input device such as a keyboard used in personal computers (PCs) or notebook computers has a limitation in downsizing the input device. Thus, the input device has a difficulty in making the information equipment small-sized. Also, in case of a touch screen-type input device in employed in personal data assistances (PDAs) or a keypad-type input device employed in cellular phones, users suffer from an inconvenience that an input speed is low and a possibility of a mistaken input is high.

In order to more rapidly input characters, numerals, symbols or the like in information equipment such as the PCs, the notebook computers, the PDAs, the cellular phones, etc., a so-called one-operation and one phoneme (character) input principle is required in which one phoneme (character) is input upon one-input operation. In the case where the one-operation and one phoneme input principle is performed on Hangeul or the Korean alphabet, buttons or input keys for inputting more than 24 characters need to be arranged on the information equipment. In the case where a language of a character to be input is Japanese alphabet or another foreign language, a relatively increased number of buttons or input keys may be required for the input devices as compared to the case of Hangeul.

However, since a conventional input device used in various information equipment adopts an input scheme in which an associated character is assigned to each input key and the input key is tapped or depressed with a user's finger so as to input a character, it is difficult to arrange more than 24 input keys each having the size of a finger in a personal portable information terminal such as a cellular phone in which an arrangement area of input keys is small.

For this reason, it has been difficult to miniaturize a keyboard so far. In case of a cellular phone, since more than 24 Hangeul characters must be input using only 12 buttons, one button is inevitably overlappingly assigned with a plurality of characters. As a result, a repetitive input phenomenon frequently occurs in which a user depresses corresponding buttons twice or thrice in order to input one character (phoneme), which contributes to an increase of a character input time to thereby cause an inconvenience to the user.

Recently, the technology of small-sized terminals such cellular phones or PDAs follows a trend toward large-scale of the screen so as to efficiently provide more various information than TV, the Internet, etc., do. Accordingly, among products put on the market presently, some products employ a touch screen-type liquid crystal screen so that a user can input a character through the touch screen without eliminating a separate input space. In this case, the touch screen is advantageously maximized, but it is still difficult to arrange a sufficient number of keys for performing a character input and executing various functional commands on the touch screen. In other words, the entire screen cannot be assigned as an input keyboard. Also, in the case where the size of a key is made small in order to arrange the sufficient number of keys on a partial region of the touch screen, small keys are densely arranged on the touch screen, thereby leading to erroneous typing during the input operation. Further, it is actually difficult to rapidly input a character as in a keyboard.

Furthermore, in the case where a small number of keys are arranged on the touch-screen to magnify the size of keys, more than two keys must be selected repetitively so as to input a desired character, making it impossible to rapidly input it.

In order to address and solve such problems, there has been proposed a character input method in which certain characters such as heaven (.), earth ( [symbol] ) and man ( [symbol] ) meaning the three basic components of the universe are combined to input a desired character. However, this method still could not solve the repetitive input phenomenon. Further, in case of the English alphabet, an input method which is called ‘T9’ has been proposed. But such an input method encounters a problem in that the one-operation and one phoneme-input principle is not performed in which one phoneme (character) is input upon one input operation.

Moreover, there has been proposed an input technique such as a keyboard which can be held by hand with it rolled up, a virtual laser keyboard in which when keys of the keyboard are projected onto the bottom and the projected keys are depressed using a finger above the bottom, the position of the used finger is sensed to achieve the input operation, or the like.

However, this kind of input device gives users an inconvenience of having to always carry around. Also, since such an input device has a problem in that since a character can be input only in a state where the input device is placed on the bottom, the input device is unsuitable for a personal portable information terminal which requires a character to be input with it held by hand during the traveling.

### DISCLOSURE OF INVENTION

### Technical Problem

Accordingly, the present invention has been made in an effort to solve the aforementioned problems occurring in the prior art, and it is an object of the present invention to provide a character input device which allows all the characters which it is desired to input to be arranged in a minimum input region so as to be suitable for miniaturization, as well as allows each of the arranged characters to be input through only one-input operation so as to enable rapid and correct input of a character.

### Technical Solution

The above object is achieved by a character input device including a base having an input region; one or more sensing sections provided at the input region for sensing a contact with the input region or a contact movement to the input region; and a control unit for extracting data corresponding to each input operation from a memory unit and inputting the extracted character data, according to the position of a contact point or the movement direction of the contact point sensed by the sensing section relative to a reference input section provided at the input region.

The sensing section may allow the input region to be divided correspondingly to a plurality of direction indicating sections disposed at different circumferential positions spaced apart radially outwardly from the reference input section, and the control unit may extract and inputs data allocated to each direction indicating section corresponding to the sensing section that has sensed the contact.

The sensing section may be distributed on the entire area of the input region, except for the reference input section, the input region having a plurality of direction indicating sections disposed equidistantly at different circumferential positions spaced apart radially outwardly from the reference input section.

The input operation may be performed in such a fashion that the contact point is moved radially outwardly from the reference input section toward each of the direction indicating sections.

The input operation may be performed in such a fashion that the contact point is moved radially inwardly from each of the direction indicating sections toward the reference input section.

The input operation may be performed in such a fashion that the contact point is moved from any one of the direction indicating sections to another direction indicating section while passing through the reference input section.

The input operation may be performed in such a fashion that the contact point is moved from each of the direction indicating sections to the tangential direction of a circle having a predetermined radius from the center of the reference input section.

The control unit may input the data corresponding to each input operation by separating different signals depending on the movement direction of the contact point at the each direction indicating section.

The input operation may be performed in such a fashion that the contact point is moved in the circumferential direction around the reference input section.

The control unit extracts and inputs different characters depending on each direction indicating section which the input operation starts from and ends at, and the direction and the distance of the movement of the contact point for the input operation.

The input operation may be performed in such a fashion that the contact point is moved forward and rearward at respective direction indicating sections around the reference input section.

The input operation may be performed in such a fashion that the contact point is moved leftward and rightward at respective direction indicating sections around the reference input section.

The input operation may be performed in such a fashion that the contact point is moved forward and rearward, and leftward and rightward at respective direction indicating sections around the reference input section.

The reference input section comprises a reference input sensing section for sensing a contact therewith.

The respective input operations may be performed in a combination of more than two input operations so as to input a Korean character or an English character.

The respective input operations may be performed in an additional combination of more than one input operation so as to input a numeral, a symbol, a mode switch or a function.

The direction indicating sections are provided in any one of four to twelve directions.

In the case where the input operation may be performed through the movement of the contact point, a multiple-stage input operation, i.e., a more than two-stage input operation is performed depending on a difference in the movement distance of the contact point.

The sensing section may comprise a depression sensing section at the bottom thereof for detecting the depression of each direction indicating section to thereby enable a multiple-stage input operation, i.e., a more than two-stage input operation depending on the strength of the depression.

The sensing section may comprise a touch pad provided at the input region.

The sensing section may comprise a touch screen.

The reference input section or at least one of the direction indicating sections may comprise direction indicators for indicating the movement direction of the contact point for the input operation at the proximity thereof.

The direction indicators may display a character input by the input operation according to each direction indicator.

The direction indicators may vary in size and color depending on a character input mode in which a character is input.

The reference input section may be provided so as to be movable in the input region.

A standby region may be positioned at one side of the input region comprises, and wherein when the contact point is moved to the standby region by a drag operation in a state where the reference input section or any one of the direction indicators is touched, the direction indicator may be hidden into the touch screen and when the reference input section is touched so as to return to the input region, the direction indicators may be re-displayed on the input region.

In this case, the reference input section or the direction indicators may be provided so as to adjustable in transparency.

The reference input section may be provided at least two in number so as to be arranged vertically at the edge of the input region and spaced apart from each other at a predetermined interval.

The reference input section may be provided at least two in number so as to be arranged horizontally at the left and right sides of the input region.

The reference input section and the sensing section may be provided two in number, respectively, at the upper and lower positions or the left and right positions of the base adjacent to the touch screen.

The character input device may further comprise a display section for displaying the character extracted by the control unit thereon, the display section including a character display part for displaying characters, etc., assigned for the each input operation thereon.

The character input device may further comprise a display section provided at the base for displaying the character extracted by the control unit thereon, the display section including a character display part provided at one side thereof for displaying characters, etc., assigned for the each input operation thereon.

In the case where the operation mode of the character input device may be switched from a character input mode to a mouse input mode, the movement of a pointer is performed by the movement of the contact point and the left and right button functions of the mouse are performed by the touch of the mouse.

In the case where the operation mode of the character input device is switched from a character input mode to a joystick input mode, the movement of a game character may be performed by the movement of the contact point and various manipulation functions of the game character may be performed by the touch of the game character.

During the movement of the contact point, as the contact point goes far away from the reference input section 30, the movement speed of the pointer or the game character may be gradually increased.

The reference input section may be provided in two sets at the input region, such that the movement of the mouse pointer or the game character is performed by one of the two reference input sections, and the functions of the left and right button of the mouse or various manipulation functions of the game character are performed by the other reference input section.

The direction indicating sections may be provided eight in number so that the eight characters are input by touching them, and the contact point is moved radially inwardly from each of the eight direction indicating sections to the reference input section and is moved radially outwardly from the reference input section to each of the eight direction indicating sections so that a total of 24 characters can be input.

The direction indicating sections may be provided four in number so that the four characters are input by touching them, and the contact point is moved radially inwardly from each of the four direction indicating sections to the reference input section and is moved radially outwardly from the reference input section to each of the four direction indicating sections so that a total of 12 characters can be input, and where the reference input section and the direction indicating sections are provided in pairs at the left and right sides of the input region so that a total of 24 characters can be input.

According to another aspect of the present invention, there is provided a character input device comprising: a touch screen in which an input region is provided; a reference input section provided at the input region; four direction indicating sections disposed equidistantly at different circumferential positions spaced apart radially outwardly from the reference input section; direction indicators provided at one side of the reference input section and the each direction indicating section for indicating the movement direction of a contact point for the input operation performed at the reference input section and the each direction indicating section; and a control unit for extracting data corresponding to each input operation from a memory unit and inputting the extracted data, according to a contact with the each direction indicating section detected by the touch screen, the movement direction of the contact point passing through the reference input section or the forward/rearward and leftward/rightward movement directions of the contact point at the each direction indicating section.

In this case, the touch screen may employ a touch screen.

The character input device may further comprise four auxiliary direction indicating sections provided between the respective direction indicating sections.

Vowel characters may be input by the movement of the contact point passing through the reference input section, consonant characters may be input by the forward/rearward and leftward/rightward movement directions of the contact point at the each direction indicating section, and various functional commands may be input by the contact with the each direction indicating section.

The reference input section, the direction indicating sections and the direction indicators may be provided two in number, respectively, at the left and right sides on the touch screen to thereby include two input sets.

The movement direction of the contact point passing through the reference input section may be provided in the form of any one of four directions and eight directions.

According to another aspect of the present invention, there is provided a character input device comprising: a touch screen in which an input region is provided; a reference input section provided at the input region; four direction indicating sections disposed equidistantly at different circumferential positions spaced apart radially outwardly from the reference input section; direction indicators provided at one side of the reference input section and the each direction indicating section for indicating the movement direction of a contact point for the input operation performed at the reference input section and the each direction indicating section; a depression sensing section provided at the bottom thereof for detecting the depression of each direction indicating section; and a control unit for extracting data corresponding to each input operation from a memory unit and inputting the extracted data, according to a contact with the each direction indicating section detected by the touch screen, the depression of the each direction indicating section detected by the depression sensing section, the movement direction of the contact point passing through the reference input section and the forward/rearward and leftward/rightward movement directions of the contact point at the each direction indicating section.

In this case, the touch screen may employ a touch screen.

The consonant characters may be input by the forward/rearward and leftward/rightward movement directions of the contact point at the each direction indicating section, and vowel characters may be input by the contact with and depression of the each direction indicating section.

The character input device may further comprise four auxiliary direction indicating sections provided between the respective direction indicating sections.

Vowel characters may be input by one of the contact with the each direction indicating section and the movement of the contact point passing through the reference input section, and various functional commands may be input by the other.

The reference input section, the direction indicating sections and the direction indicators may be provided two in number, respectively, at the left and right sides on the touch screen to thereby include two input sets.

Respective different characters may be input through contact with each of the direction indicating section, movement of a contact point from the reference input section to each of the direction indicating sections, movement of a contact point from a position outside the indicating section to the direction indicating section, movement of a contact point from the direction indicating section to the position outside the direction indicating section, and movement of a contact point from the direction indicating section to the reference input section.

Respective different characters may be input through pressing on each of the direction indicating section, movement of a pressing point from the reference input section to each of the direction indicating sections, movement of a pressing point from a position outside the direction indicating section to the direction indicating section, movement of a pressing point from the direction indicating section to the position outside the direction indicating section, and movement of a pressing point from the direction indicating section to the reference input section.

A character different form those related to the individual input operations may be input through combination of the one or more input operations with circumferential movement from a specific direction indicating section to another direction indicating section in a circumferential direction.

According to another aspect of the present invention, there is provided a character input device including a touch screen provided with an input region; a ring input section provided with a plurality of direction indicating sections, the direction indication sections being provided in the input region in a ring form and being arranged while being spaced at uniform radial intervals; a pressing sensing section provided below the touch screen and configured to detect pressing on each of the direction indicating sections in the ring input section; and a control unit for extracting respective corresponding character data from memory unit and inputting the character data in response to contact on each of the direction indicating sections detected by the touch screen, pressing on each of the respective direction indicating sections detected by the pressing sensing section, and a direction of a contact point or a pressing point passing through each of the direction indicating sections in the ring input section.

Respective different characters may be input through input operation based on movement of a contact point or a pressing point from the direction indicating section through a position outside the ring input section to another direction indicating section and input operation based on movement of a contact point or a pressing point from a position outside the ring input section through the direction indicating section and a position outside the ring input section to another direction indicating section.

Respective different characters may be input through input operation based on movement of a contact point or a pressing point from the direction indicating section through a position outside the ring input section to another direction indicating section and input operation based on movement of a contact point or a pressing point from the direction indicating section through a position outside the ring input section and another direction indicating section to a position outside the ring input section.

A reference input section may be further provided at a center of the ring input section; and respective different characters may be input through input operation based on movement of a contact point or a pressing point from each of the direction indicating sections to a position outside the ring input section, input operation based on movement of a contact point or a pressing point from the direction indicating section through a position outside the ring input section to the reference input section, input operation based on movement of a contact point or a pressing point from the direction indicating section through a position outside the ring input section and the reference input section, input operation based on movement of a contact point or a pressing point from the direction indicating section through a position outside the ring input section and the reference input section to another direction indicating section, and input operation based on movement of a contact point or a pressing point from a position outside the ring input section through any one of the direction indicating sections, the reference input section and another direction indicating section again to a position outside the ring input section.

According to another aspect of the present invention, there is provided a character input device including a touch screen provided with an input region; two reference input sections provided on right and left sides of the input region; four direction indicating sections arranged around the respective reference input section to have uniform radial distance therebetween; direction indicators provided on sides of the reference input section and the respective direction indicating sections, and configured to display one or more directions of a contact point performed in the reference input sections and the direction indicating sections; and a control unit for extracting respective corresponding character data from memory unit and inputting the character data in response to contact on each of the direction indicating sections detected by the touch screen, each of directions of a contact point passing through each of the reference input sections, and each of directions of a contact point from each of the direction indicating sections.

The directions of the movement of the contact point from each of the direction indicating sections may include one or more of a vertical direction and a lateral direction.

The directions of the movement of the contact point from each of the direction indicating sections may include one or more of an inward direction toward the reference input section and an outward direction.

The direction indicating sections may be a total of 8 direction indicating sections, including four additional direction indicating sections, and the directions of the movement of the contact point from each of the direction indicating sections may include one or more of an inward direction toward the reference input section and an outward direction.

The directions of the movement of the contact point passing through the reference input section may be 4 or 8 in number.

The character input device may further include four auxiliary direction indicating sections provided between the respective direction indicating sections.

Various functional commands may be input through movement of the contact point passing through the reference input sections, and contact with and movement related to the respective direction indicating sections and auxiliary direction indicating sections.

Vowel characters are input through contact with the respective direction indicating sections, and consonant characters may be input through the movement of the contact point.

### ADVANTAGEOUS EFFECTS

Accordingly, a character input device of the present invention allows all the characters which it is desired to input to be arranged in a minimum input region where a reference input section is disposed as to be suitable for miniaturization, as well as allows each of the arranged characters to be input through only one-input operation so as to enable rapid and correct input of a character.

### BRIEF DESCRIPTION OF THE DRAWINGS

FIG. 1 is a perspective view showing a character input device according to one embodiment of the present invention;

FIG. 2 is an enlarged view showing various modifications of a sensing section shown in FIG. 1;

FIG. 3 is a plan view showing a character input device according to another embodiment of the present invention;

FIGS. 4 and 5 are schematic views showing various modifications of an input operation performed by a character input device according to the present invention;

FIGS. 6 to 8 are enlarged views showing various modifications of a direction indicating section of a character input device according to the present invention;

FIGS. 9 and 10 are plan views each showing a dual set-type input device according to the present invention character;

FIGS. 11 and 12 are plan views showing the arrangements of a reference input section and direction indicating sections according to various embodiments of the present invention;

FIG. 13 is a configuration diagram illustrating an embodiment of the present invention;

FIGS. 14 and 15 are configuration diagrams showing the basic input operations of the present invention;

FIGS. 16 to 18 are configuration diagrams illustrating the circumferential movement input of the present invention;

FIG. 19 is a configuration diagram showing a form in which all various input operations of the present invention are included in a single device;

FIGS. 20 to 22 are configuration diagrams illustrating the combination of the basic operation of the present invention and circumferential movement input; and

FIG. 23 is a configuration diagram illustrating the variation of the input operation of the present invention.

### MODE FOR THE INVENTION

Reference will now be made in detail to the preferred embodiments of the present invention with reference to the attached drawings.

Referring to the drawings, a character input device 1 according to the present invention comprises a base 10 having an input region 25; a plurality of sensing sections 20 provided at the input region 25 (see FIG. 2) for sensing a contact with the input region or a contact movement to the input region; and a control unit (not shown) for extracting character data corresponding to each input operation from a memory unit (not shown) and inputting the extracted data according to the position of a contact point or the movement direction of the contact point sensed by the sensing section 20 relative to a reference input section 30 provided at one side of the input region 25.

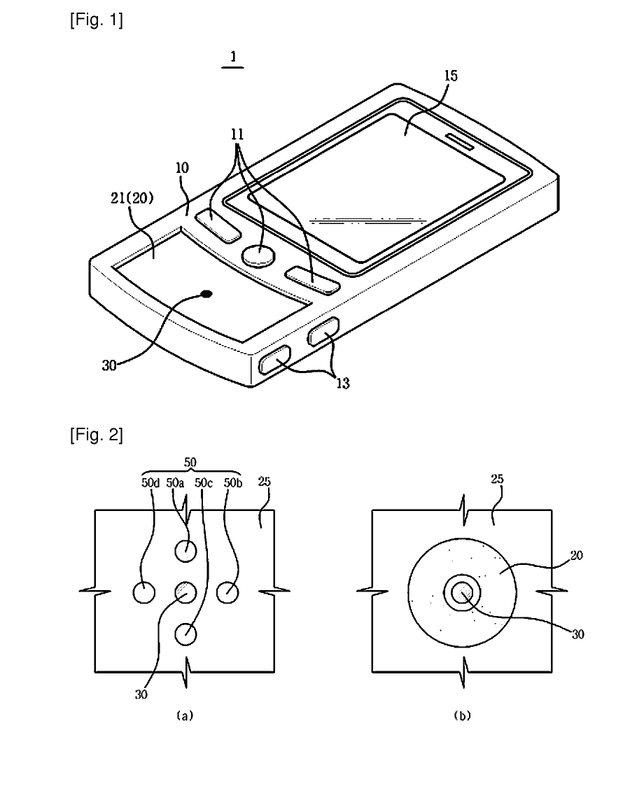

FIG. 1 is a perspective view showing a character input device according to one embodiment of the present invention.

Referring to FIG. 1, a sensing section 20 is disposed at the input region 25 (see FIG. 2) provided at one side of the base 10 so as to sense a contact with the input region 25 or a contact movement to the input region.

The sensing section 20 may be provided in various forms. For example, the sensing section 20 may be provided in the form of a touch pad 21 as shown in FIG. 1, and may be provided with a contact (or touch) sensor, a pressure sensor, a depression-detecting sensor (switch), a resistive sensor or the like in plural numbers as shown in FIGS. 1b(a) to 1b(c).

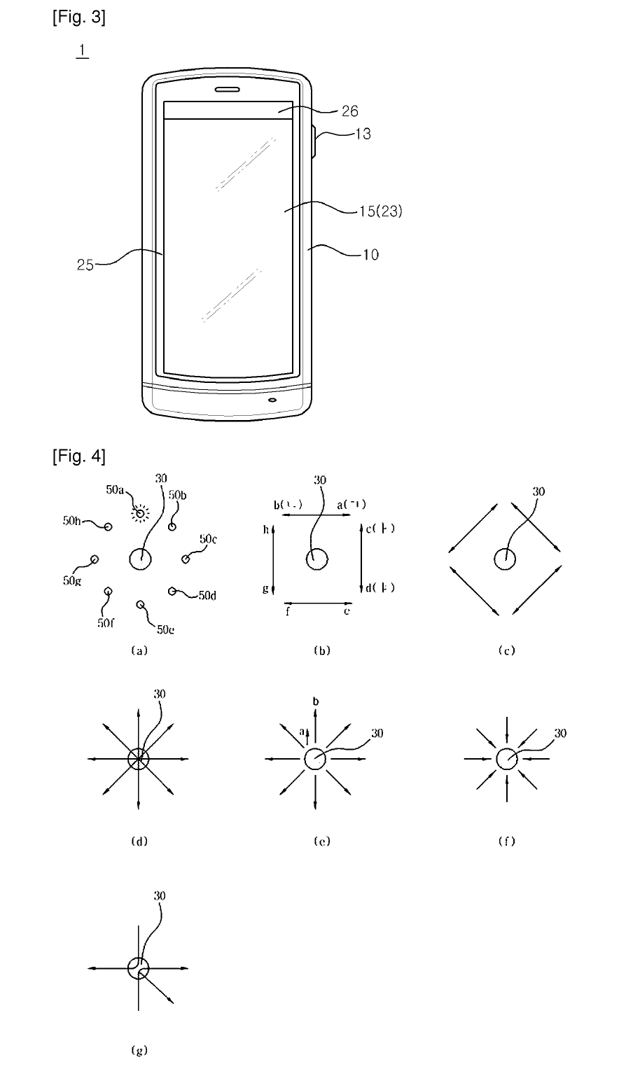

Alternatively, as shown in FIG. 3, the sensing section may be provided in the form of a touch screen 23 in which a display function is added to the touch pad 21.

That is, the sensing section 20 includes the touch pad 21 or the touch screen in which a display function is added to the touch pad 21, and a touch (contact) sensor which can sense a contact and a movement of a finger or an object.

Also, the sensing section 20 may be provided with one sensor, but may be formed in such a fashion as to be regularly arranged in plural numbers in a predetermined input space such as the touch pad 21 or the touch screen.

In the case where the sensing section 20 is provided in the form of the touch pad 21 or the touch screen 23, the input region is divided correspondingly to each direction indicating section 50 relative to the reference input section.

Further, the sensing section 20 may be provided on the entire area of the input region 25 as shown in FIG. 1, and may be provided in a certain area of a portion corresponding on each direction indicating section 50, as shown in FIG. 2(a). In addition, the sensing section 20 may be provided on only a partial area of the input region 25 relative to the reference input section 30 as shown in FIG. 2(b).

A reference input section 30 is provided on one side of the input region 25.

The reference input section 30 acts as a reference for contact or the movement of a contact point detected by the sensing section 20, and enables a control unit (not shown) to determine the relative position of the contact point or the movement direction of the contact point.

The reference input section 30 may be fixedly provided on one side of the input region 25 as shown in FIG. 2, or may be moved through dragging in the case where the sensing section 20 is provided in the form of the touch pad 21 or touch screen 23, as shown in FIGS. 1 and 3.

In the case of the latter case, referring to FIG. 3 as an example, when the character input device 1 is not in a character input mode, the reference input section 30 or direction indicator 33 is located in a standby region 26 on one side of the touch screen 23, a user drags the reference input section 30 or direction indicator 33, located in the standby region 26, to the input region 25 when the operational mode is switched to a character input mode, and then a character can be input.

In this case, the user can freely select the location of the reference input section 30 for the input of characters, and thus the user's convenience is increased.

Here, the direction indicator 33 may be hidden in the standby region 26, and may appear when the reference input section 30 is moved to the input region 25.

When the reference input section 30 is located in the standby region 26, it may disappear after a predetermined period has elapsed. Furthermore, when the standby region 26 is touched or after a predetermined period has elapsed after touching, the reference input section 30 may appear again.

Meanwhile, a reference input sensing section (not shown) for detecting contact with the reference input section 30 may be further provided.

Referring to FIG. 2, direction indicating sections 50 are radially arranged around the reference input section 30.

It is preferred that the direction indicating sections 50 be arranged to have a uniform distance from the reference input section 30 and to have a uniform included angle therebetween.

The number of direction indicating sections 50 may be various. For example, the number of direction indicating sections 50 may be four, as shown in FIG. 2, or may be 8 or 12.

The direction indicating sections 50 are assigned respective characters, and the control unit extracts a character assigned to each of the direction indicating sections 50 from a memory unit and inputs the characters when contact with the direction indicating section 50 is detected.

Here, as shown in FIG. 1, a display section 15 for displaying a character extracted by the control unit may be provided on the other side of the base 10.

In this case, character display parts 56 for displaying characters assigned to respective input operations based on the reference input section 30 may be further provided in the display section 15.

The character display parts 56 display respective input operations based on the reference input section 30 and characters assigned to respective input operations, thereby enabling the user to input characters while viewing the character display parts 56.

It is apparent that the character display parts 56 may be selectively displayed or hidden through a user's manipulation.

### First Embodiment

The basic input operation of the character input device 1 as constructed above according to this embodiment will be described in detail below with reference to FIGS. 4 and 5.

The term ‘character’ as used herein, refers to consonants or vowels used to represent languages of each country such as Korean alphabet (Hangeul), English alphabet, Japanese alphabet, etc., and is defined as a narrow meaning excluding numerals, symbols or the like.

Referring to FIG. 4, eight direction indicating sections 50a to 50h are disposed equidistantly at different circumferential positions spaced apart radially outwardly from the reference input section 30. A character is assigned to each direction indicating section 50, so that when any contact with a corresponding direction indicating section 50a is sensed, the control unit extracts a character code assigned to the sensed corresponding direction indicating section 50a from the memory unit and inputs the extracted character code.

In the meantime, the sensing section 20 may be further provided with a depression-sensing section (not shown) for sensing the depression of each direction indicating section 50 at a lower portion thereof. In this case, a two-stage input operation can be performed through the touching or depression of each direction indicating section 50. Alternatively, the depression-sensing section may be also provided in the form of a pressure sensor so as to enable a more than two-stage input operation according to the strength of depression of each direction indicating section 50 through only depression.

FIG. 4(b) shows examples of various character inputs according to the movement direction of a contact point at the outside of the reference input section 30.

For example, when the contact point is moved from the left to the right at a position above the reference input section 30 (see ‘a’ of FIG. 4(b)), a Hangeul consonant ‘ [symbol] ’ is input, and when the contact point is moved from the right to the left at the position above the reference input section 30 (see ‘b’ of FIG. 4(b)), a Hangeul consonant ‘ [symbol] ’ is input. Also, when the contact point is moved from the bottom to the top at the right side of the reference input section 30 (see ‘c’ of FIG. 5(b)), a Hangeul vowel ‘ [symbol] ’ is input, and when the contact point is moved from the top to the bottom at the right side of the reference input section 30 (see ‘d’ of FIG. 5(b)), a Hangeul vowel ‘ [symbol] ’ is input.

That is, the control unit determines the movement direction of the contact point based on the coordinates of the initial and the last positions of the contact point by using the reference input section 30 as an origin of coordinates when the movement of the contact point is sensed by the sensing section 20 to thereby extract a character code corresponding to each input operation by distinguishing the respective input operations from one another.

Similarly, FIG. 4(c) shows a state where the contact point is moved at an oblique angle (for example, at an angle of 45 degrees) relative to the reference input section 30. FIG. 4(d) shows a state where the contact point is moved while passing through the reference input section 30. FIG. 4(e) shows a state where the contact point is moved radially outwardly from the reference input section 30. FIG. 4(f) shows a state where the contact point is moved radially inwardly toward the reference input section 30.

In the meantime, FIG. 4(g) shows a state where the contact point passes through the reference input section 30 at a given angle. That is, the contact point may be moved from a direction indicating section 50 positioned in the direction of the hour hand when the clock shows six o'clock to a direction indicating section 50 positioned in the direction of the hour hand when the clock shows three o'clock or four thirty via the reference input section 30. Also, different characters can be input depending on the position from which the contact point starts and the position of a direction indicating section 50 which the contact point reaches via the reference input section 30.

Meanwhile, referring to FIG. 5, FIG. 5(a) shows a state where the contact point is moved vertically outwardly from the reference input section 30. FIG. 5(b) shows a state where the contact point is moved outwardly and laterally from the reference input section 30. FIG. 5(c) shows a state where the contact point is moved vertically and laterally at respective directions. FIGS. 5(d) and 5(e) show states where the contact point is moved in the circumferential direction around the reference input section 30.

In brief, the character input device 1 according to the present invention separately performs respective input operations such as an input based on the position of the contact point as shown in FIG. 4(a) and an input based on the movement of the contact point as shown in FIGS. 4(b) to 5, thereby input characters assigned to the respective input operations.

In this case, the respective input operations shown in FIGS. 4 and 5 may be applied separately or in a combination of more than two inputs.

First, the case where the above-mentioned respective input operations are applied separately will be described hereinafter. In FIG. 4(a), a total of eight characters can be input through the contact with eight direction indicating sections 50, a total of eight characters can also be input through the contact can be input through the movement of the contact point in FIG. 4(b), and a total of 16 characters can be input in such a fashion that four characters are input every oblique direction in FIG. 4(c).

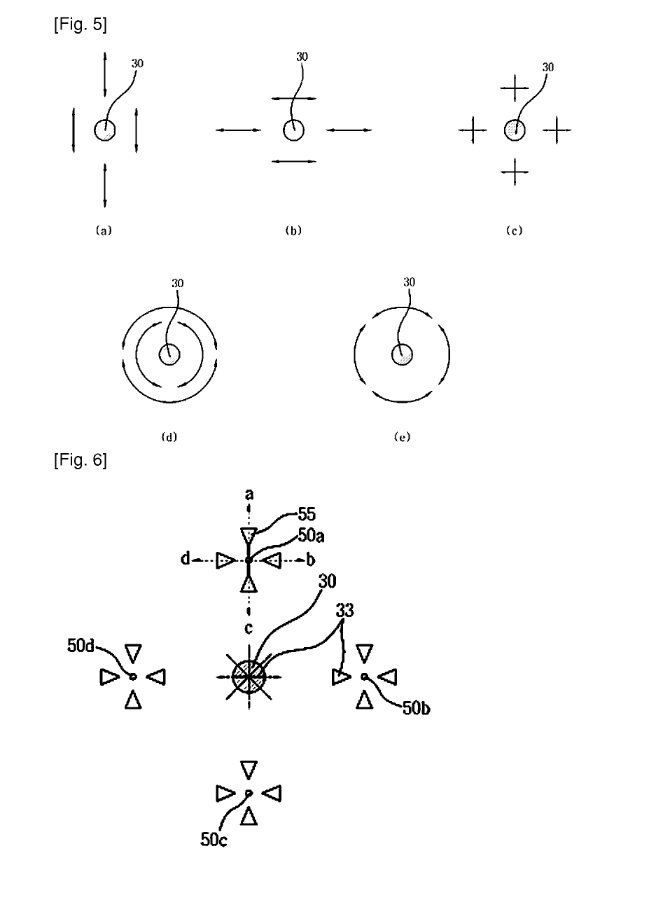

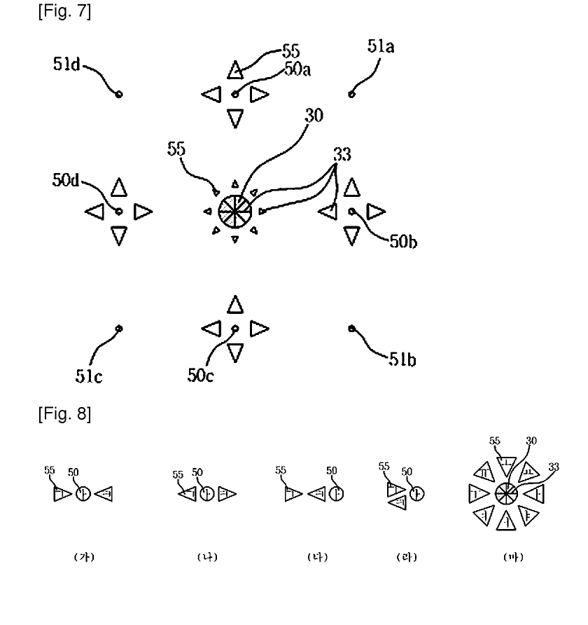

Meanwhile, as shown in FIGS. 6 and 7, each of the direction indicating sections 50 may be provided with direction indicators 55 for indicating the movement directions of the contact point passing through each direction indicating section 50.

Also, a character to be input according to each input operation can be displayed on each direction indicator 55 or each direction indicating section 50 as shown in FIG. 8.

The case where more than two basic input operations are combined will be described hereinafter with reference to FIG. 6.

FIG. 6 shows a combination of the input operations shown in FIG. 4(a) and FIG. 5(c).

That is, four direction indicating sections 50a, 50b, 50c and 50d are arranged around the reference input section 30 so that four characters can be input through the contact with each direction indicating section 50 and 16 characters can be input through the movement of the contact point at each direction indicating section 50. As a result, a total of 20 characters can be input.

In this case, the number of the direction indicating sections 50 can be modified freely. Thus, if eight direction indicating section 50 are provided and the input of the character is possible through the four movements of the contact point at each direction indicating section 50, a total of 40 characters can be input.

Thus, in case of the Hangeul, all the 24 Korean characters can be sufficiently assigned to the direction indicating sections and the direction indicators, and in case of the English alphabet, all the 26 English characters can sufficiently be assigned to the direction indicating sections and the direction indicators. Spare characters such as cancel, enter, numeral, symbol and the like can be assigned to the direction indicating sections and the direction indicators with respect to the remaining input operations.

Also, in the case where more than three basic input operations are combined, Korean characters, English characters, numerals, symbols as well as functions such as cancel, enter and the like can be assigned to the direction indicating sections and the direction indicators, so that a desired character can be input immediately even without any switch of an input mode.

Therefore, the character input device 1 of the present invention allows all the characters which it is desired to input to be arranged in a minimum input region on which the reference input section 30 is disposed so as to be suitable for miniaturization, as well as allows each of the arranged characters to be input through only one-input operation so as to enable rapid and correct input of a character.

In addition, the character input device of the present invention may be configured such that in case of the input operation based on the movement of the contact point, respective input operations may be performed in a multi-stage input scheme depending on a difference in the movement distance of the contact point.

For example, in case of the input operation in which the contact point is moved form the reference input section 30 to a direction indicating section 50 positioned in the direction of the hour hand when the click shows 12 o'clock as shown in FIG. 4(b), if the movement distance ‘a’ of the contact point is relatively short, the input operation is performed in a one-stage input scheme, and the movement distance ‘b’ of the contact point is relatively long, the input operation is performed in a two-stage input scheme, so that a total of 16 characters can be input through only the basic input operation of FIG. 4(b).

Alternatively, the sensing section 20 is further provided with a depression sensing section (not shown) at the bottom thereof for detecting the depression of each direction indicating section 50, so that the sensing section 20 detects any touch thereof and the depression sensing section detects any depression of the sensing section to thereby enable the multiple-stage input operation, i.e., more than two-stage input operation.

In addition, the depression sensing section may be provided in the form of a pressure sensor, etc., to thereby enable the multiple-stage input operation depending on the strength of the depression through only the depression.

In the meantime, the character input device 1 according to the present invention may be configured such that a character can be input through the reference input section 30 besides the respective basic input operations as described above.

For example, the input operation can be achieved through a contact with the reference input section 30 or the movement of the contact point passing through the reference input section 30 as shown FIG. 6.

That is, in FIG. 6, eight characters can be input through only the reference input section 30.

In this case, the reference input section 30 is further provided with direction indicators 33 for indicating the movement direction of the contact point for the input operations performed at the reference input section 30.

The direction indicators 33 may be provided on the reference input section 30 in the shape of lines distinguished depending on the movement direction of the contact point, as shown in FIG. 6, and may be provided circumferentially around the reference input section 30 in an arrow shape corresponding to each movement direction of the contract point, as shown in FIG. 7.

Here, it is apparent that both the direction distinguishing lines and the arrows, or the direction distinguishing lines or arrows may be provided.

Accordingly, the respective input operations, the multiple-stage configuration of the respective input operations and the character input operations through the reference input section 30 can be applied separately or in a combination thereof to thereby enable all the characters which it is desired to input to be displayed.

In the meantime, in the case where the respective basic input operations shown in FIGS. 4 and 5 and the input operation through the reference input section 30 are combined, characters can be variously assigned for the respective input operations depending on the kind thereof.

For example, vowel characters such as Korean vowels, English vowels, etc., can be assigned for the respective input operations through the reference input section 30, and consonant characters such as Korean consonants, English consonants, etc., can be assigned for the respective input operations performed at positions spaced apart outwardly from the reference input section 30.

Also, the reference input section 30 may be assigned with numerals, symbols or various functions such as cancel, enter and the like besides characters.

Further, vowel characters may be assigned for the input operation through a contact with each direction indicating section 50, consonant characters may be assigned for the input operation through the movement of the contact point, and numerals, symbols or various functions may be assigned for the input operation through the reference input section 30.

In the meantime, auxiliary direction indicating sections 51a, 51b, 51c and 51d may further be provided between the respective direction indicating sections 50 which do not allow the input operation through the movement of the contact point to be performed.

The auxiliary direction indicating sections 51a, 51b, 51c and 51d are configured such that they senses only any contact so as to allow characters assigned thereto to be input.

Meanwhile, the character input device 1 according to the present invention further includes direction indicators 55 for indicating the movement direction of the contact point for the respective input operations and displaying characters to be input through the respective input operations.

For example, as shown in FIGS. 6 and 7, the direction indicators 55 may be provided around the each direction indicating section 50 in the arrow shape corresponding to each input operation.

Of source, the direction indicators 55, as shown in FIG. 8, can be modified freely in shape and arrangement.

Meanwhile, as shown in FIG. 8, each of the direction indicators 55 can display characters assigned for the respective input operations.

In this case, the characters displayed on the respective direction indicators 55 may be set to be modified depending on an input mode. For example, in case of a Korean character input mode, only Korean consonants and vowels are displayed on the respective direction indicators 55. In case of an English character input mode, only English consonants and vowels are displayed on the respective direction indicators 55. In addition, the direction indicators 55 can be hidden by a user's skillful manipulation.

In the meantime, a character display section 56 may be provided at one side of display section 15 or the touch screen 23 so as to allow each input operation and the characters assigned for the input operation to be displayed thereon in place of the direction indicators 55. In this case, it is, of course, possible to modify the kind of characters to be displayed on the character display section 56 depending on an input mode.

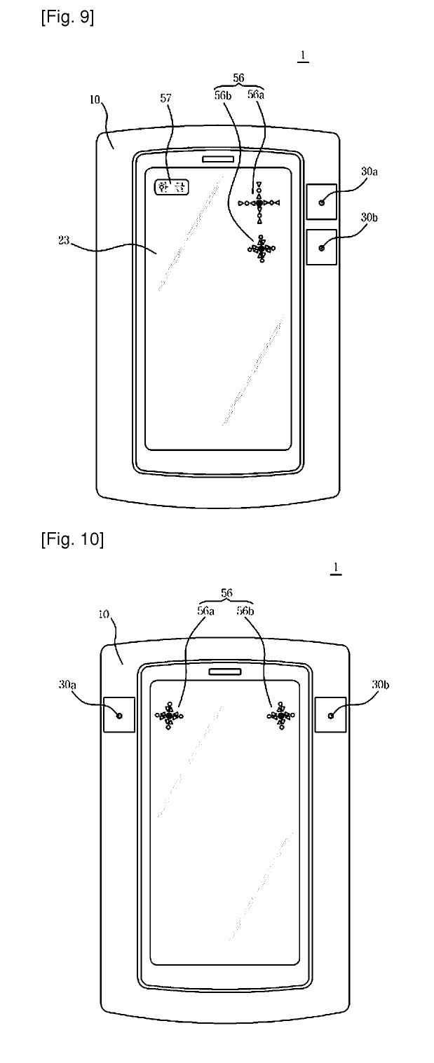

Meanwhile, as shown in FIG. 9, a mode display part 57 for indicating a current character input mode may be further provided on one side of the display section 15 or touch screen 23.

Furthermore, the character input device 1 according to the present invention may be configured to provide two reference input sections 30 and have two input sets.

Here, the two input sets may be provided on the base 10, as shown in FIGS. 9 and 10, or may be provided on the touch pad 21 or touch screen 23.

Furthermore, the respective input sets may be vertically arranged, as shown in FIG. 9, or may be laterally arranged, as shown in FIG. 10.

In this case, the respective input sets may be assigned the same input operations or different input operations.

That is, any one of the two input sets is configured based on the combination of FIG. 4(a) and FIG. 5(c), and the remaining input set may be configured based on only 5(d).

Alternatively, the input sets shown in FIGS. 6 and 7 may be laterally arranged. In this case, vowel characters can be input through the movement of the contact point passing through the reference input section 30, consonant characters can be input through the vertical or lateral movement of the contact point within the direction indicating section 50, and various function commands, such as Enter, Space or Cancel, can be input through contact with the respective direction indicating sections 50.

In the case where two input sets are provided as described above, the number of the directions of the movement of the contact point passing through the reference input section 30 may be four.

Alternatively, in the above-described case, a pressing sensing section may be provided on the sensing section 20 (including the touch pad 21 or the touch screen 23), thereby enabling multi-stage input to be performed through contact or pressing related to the respective direction indicating sections 50.

In this case, consonant characters may be input through the lateral movement of the contact point in the respective direction indicating sections 50, while vowel characters may be input through touching or pressing in respective direction indicating sections 50.

Meanwhile, in the case where two auxiliary direction indicating sections 51 are provided, vowel character can be input through any one of contact and the movement of the contact point in the direction indicating sections 50 or the movement of the contact point passing through the reference input section 30, while various command, such as Enter, Space or Cancel, can be input through another one.

In the meantime, in providing two sets of input devices, the movement direction of the contact point at each direction indicating section 50 may be set such that a character is input only in the forward and rearward directions, the leftward and rightward directions, or the inward and outward directions.

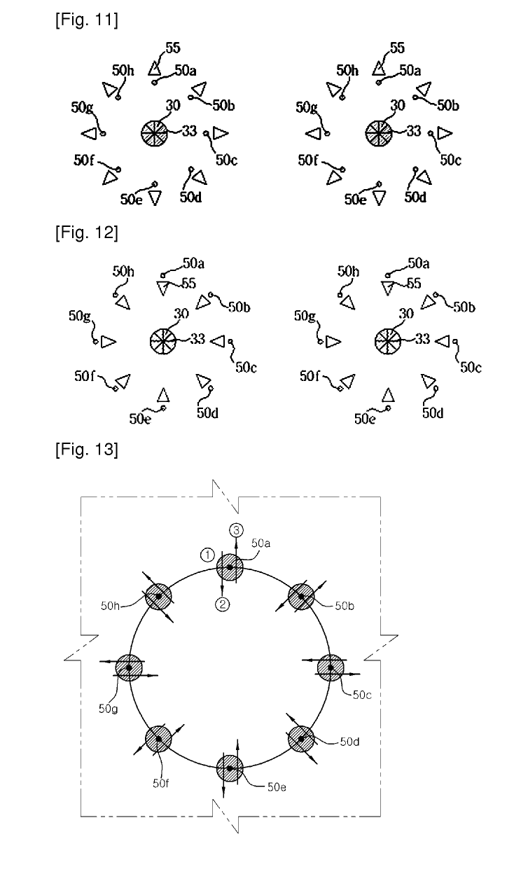

For example, as shown in FIGS. 11 and 12, a reference input section 30 is disposed at the right and left sides of the touch screen 23, respectively, and eight direction indicating sections 50a to 50h are disposed equidistantly at different circumferential positions spaced apart radially outwardly from the reference input section 30. Each direction indicating section 50 may be configured to have only direction indicators 55 which indicate an outward contact movement (see FIG. 11) or an inward contact movement (see FIG. 12) of the contact point relative to the reference input section 30.

The combination of the input operations included in each input device set can be, of course, modified depending on the kind of the input mode.

For example, a combination of the input operations shown in FIGS. 4(a) and 4(b) is used in a Korean character input mode, and a combination of the input operations shown in FIGS. 4(d) and 4(e) is used in an English character input mode.

The character input device 1 according to the present invention may be replaced with a mouse. For example, when a user manipulates a switch key 13 provided at the base 10 or performs the input operation on the touch screen 23 to switch the operation mode from the character input mode to a mouse input mode, a mouse function can be performed through the touching or the movement of the contact point at the input region 25.

In other words, the movement of a mouse pointer can be performed by the movement of the contact point and a function of a left button of the mouse can be performed by the touching.

In this case, the left button of the mouse includes typically functions such as depression of left and right buttons or the vertical scrolling performed in a character input device called a ‘mouse’ used in a desktop PC or a notebook PC.

In this case, particularly, as shown in FIGS. 5(d) and 5(e), the scrolling function may be performed through the input operation based on the circumferential movement of the contact point.

Meanwhile, as shown in FIG. 10, the reference input section 30 of the present invention are provided in two sets at the right and left sides of the upper portion of the touch screen 23, the character input device set at the right side of the touch screen can manipulate a pointer function of a joystick, i.e., the movement of a game character, and the character input device set at the left side of the touch screen can input commands for performing various motions of the character.

In case of the movement of the game character, if the contact point in close contact with the input region 25 goes far away from the reference input section 30, it is possible to increase the movement speed of the pointer or the game character.

### Second Embodiment

Next, a second embodiment of the input operations of the character input device 1 according to the present invention will be described in detail with reference to FIG. 13.

As shown in FIG. 13, in the present embodiment, an input line connecting 8 direction indicating sections 50a to 50h is provided. However, since the input line is provided merely for a user's convenience, it may be omitted because the direction indicating sections 50a to 50h.

With regard to the direction indicating section 50a to 50h, respective different characters may be input through contact (contact input \textcircled{1}) related to the respective direction indicating sections, the inward movement of the contact point (inward contact input \textcircled{2}) passing through the direction indicating section, and the outward movement of the contact point (outward contact input \textcircled{3}) passing through the direction indicating section, as shown in FIG. 4(a).

For example, contact input related to the respective direction indicating sections 50a to 50h are assigned consonant characters, inward contact input related to the direction indicating sections 50a to 50h are assigned vowel characters, and outward contact input related to the respective direction indicating sections 50a to 50h are assigned consonant characters.

Accordingly, when characters assigned to the respective direction indicating sections are Hangeul consonances and vowels, the input of a single syllable can be completed by sequentially performing contact input related to any one direction indicating section, inward contact input and outward contact input.

### Third Embodiment

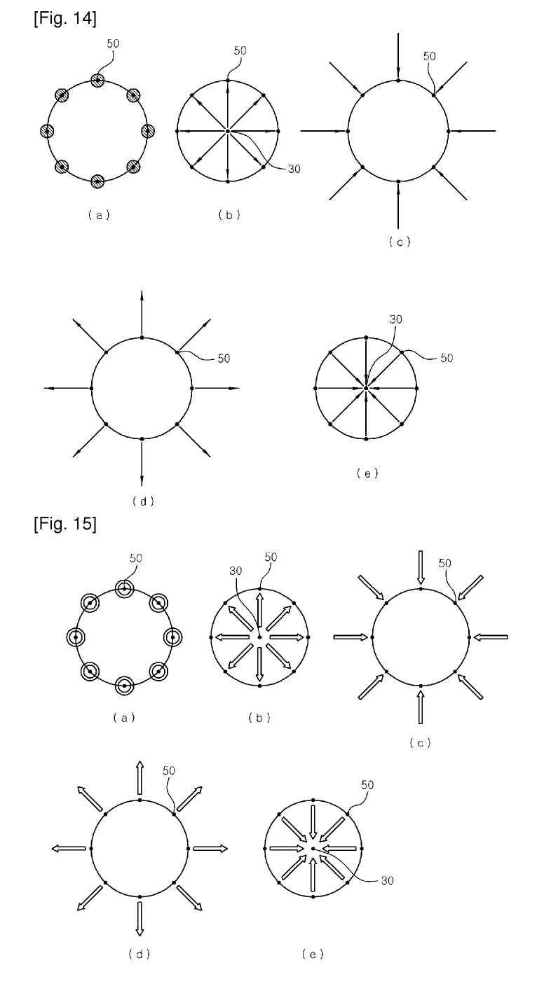

Next, a third embodiment of the input operation of the character input device 1 according to the present invention will be described in detail with reference to FIGS. 14 and 15.

In FIG. 14, various input operations related to each of the direction indicating sections 50 are shown, That is, characters assigned to respective direction indicating sections 50 may be input through contact with the respective direction indicating section 50, as shown in FIG. 14(a), and characters may be input through the movement of the contact point from the reference input section 30 to the respective direction indicating sections 50, as shown in FIG. 14(b), and characters may be input through the movement of the contact point from positions outside the respective direction indicating section 50 to the respective direction indicating sections 50, as shown in FIG. 14(c).

Alternatively, as shown in FIG. 14(d), characters may be input through the outward movement of the contact point from the respective direction indicating sections 50. Furthermore, as shown in FIG. 14(e), characters may be input through the movement of the contact point from the respective direction indicating section 50 to the reference input section 30.

Although the same character may be input through the input operations related to the respective direction indicating section 50, different characters may be input. Furthermore, a character different from characters related to respective input operations may be input through the combination of two or more input operations related to respective direction indicating sections 50.

Meanwhile, pressing on the respective direction indicating section 50 and the reference input section 30 may be detected by a pressing sensing section in such a way that the input operations shown in FIG. 14 are implemented on a touch screen and the pressing sensing section (not shown) is provided below the touch screen.

In this case, in addition to the five input operations, pressing input for pressing the respective direction indicating sections 50, and inward and outward pressing input for moving a pressing point with regard to the respective direction indicating sections may be implemented.

In greater detail, characters assigned to respective direction indicating sections 50 may be input through pressing on the respective direction indicating section 50, as shown in FIG. 15(a), and characters may be input through the movement of the pressing point from the reference input section 30 to the respective direction indicating sections 50, as shown in FIG. 15(b), and characters may be input through the movement of the pressing point from positions outside the respective direction indicating section 50 to the respective direction indicating sections 50, as shown in FIG. 14(c).

Alternatively, as shown in FIG. 15(d), characters may be input through the outward movement of the pressing point from the respective direction indicating sections 50. Furthermore, as shown in FIG. 15(e), characters may be input through the movement of the pressing point from the respective direction indicating section 50 to the reference input section 30.

Although the same character may be input through the input operations related to pressing and the movement of pressing point related to the respective direction indicating section 50, different characters may be input.

Furthermore, new characters may be input through the combination of 10 input operations shown in FIGS. 14 and 15. For example, new characters different from those related to the input operations related to the direction indicating sections 50 may be input by sequentially performing contact with the direction indicating sections 50 show in FIG. 14(a), pressing on the direction indicating section 50 shown in FIG. 15(a) and outward contact movement from the direction indicating sections 50.

### Fourth Embodiment

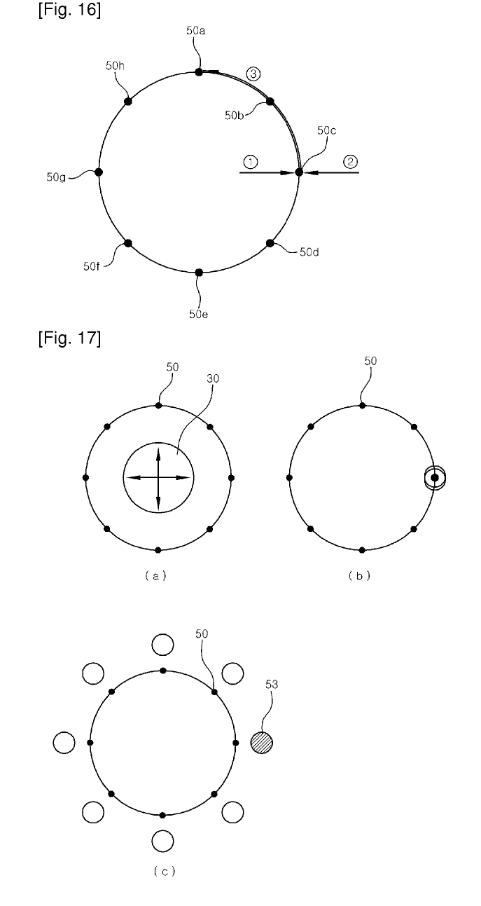

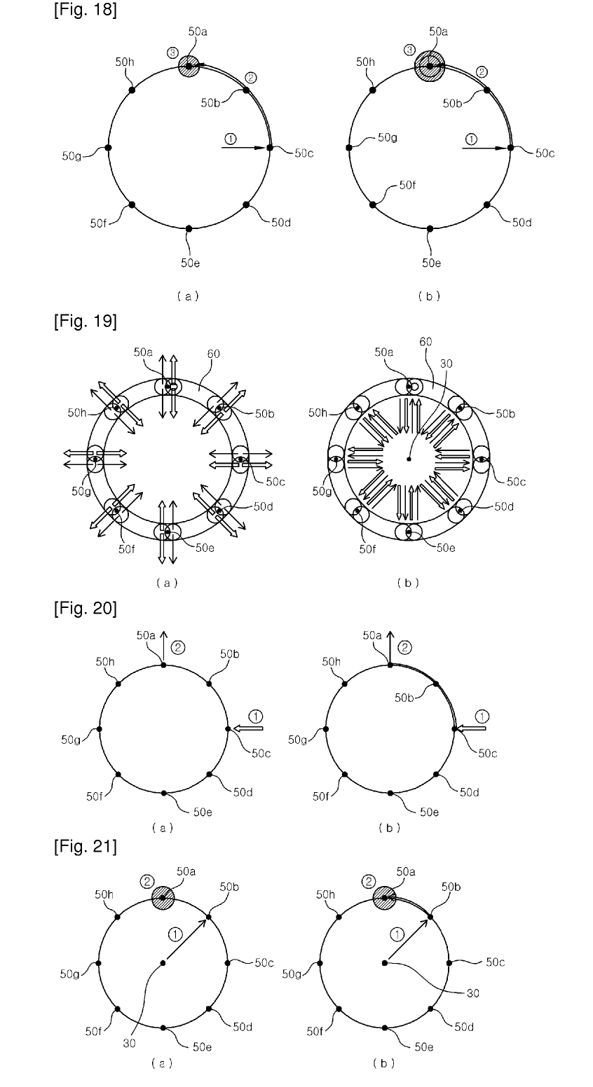

Next, a fourth embodiment of the input operation of the character input device 1 according to the present invention will be described in detail with reference to FIGS. 16 and 18.

In the present embodiment, with regard to 8 direction indicating sections 50a to 50h arranged along an input line, as shown in FIG. 16, circumferential movement input for inputting a characters through circumferential movement from a specific direction indicating section to another direction indicating section is added. The circumferential movement input allows characters assigned to initial input and final input based on the recognition of the initial input and the final input, or allows a new character to be input based on the combination of initial input and final input.

In greater detail, as shown in FIG. 16, a character may be input through the movement of the contact point from a reference input section 30 to a direction indicating section 50c in a 3 o'clock direction (\textcircled{1} in FIG. 16) or through the movement of the contact point from a position outside the direction indicating section 50c to the direction indicating section 50c in a 3 o'clock direction (\textcircled{2} in FIG. 16).

However, when circumferential movement to the direction indicating section 50a in a 12 o'clock direction is performed after \textcircled{1} of FIG. 16 has been performed (\textcircled{3} in FIG. 16), a character assigned to the direction indicating section 50c in a 3 o'clock direction with respect to \textcircled{1} of FIG. 16 and a character assigned to the direction indicating section 50a in a 12 o'clock direction with the circumferential movement of \textcircled{3} of FIG. 16 may be successively input. Alternatively, when circumferential movement to the direction indicating section 50a in a 12 o'clock direction is performed after \textcircled{2} of FIG. 16 has been performed (\textcircled{3} of FIG. 16 [symbol] ), a character assigned to the direction indicating section 50c in a 3 o'clock direction with respect to \textcircled{2} of FIG. 16 and a character assigned to in the direction indicating section 50a a 12 o'clock direction with respect to the circumferential movement of \textcircled{3} of FIG. 16 can be successively input.

In this case, circumferential movement input after \textcircled{1} of FIG. 16 and circumferential movement input after \textcircled{2} of FIG. 16 may be configured to input characters different from those related to the input of \textcircled{1} of FIG. 16, the input of \textcircled{2} of FIG. 16 and the input of \textcircled{3} of FIG. 16.

Furthermore, when circumferential movement input is performed, initial input may be configured to input a character different from characters related to individual inputs.

That is, when a reference input section 30 is provided and circumferential movement input is performed after contact movement from the reference input section 30 to each of the respective direction indicating sections 50 is performed, as shown in FIG. 17(a), a different character may be input through the contact movement. Furthermore, when circumferential movement input is performed after contact with a direction indicating section 50 at a start location is successively performed two or more times, as shown in FIG. 17(b), a character different from a character related to contact with the direction indicating section 50. Furthermore, when circumferential movement input is performed after movement to the respective direction indicating section 50 has been performed along with contact with an auxiliary indicator 53 provided outside each of the direction indicating sections 50, as shown in FIG. 17(c), a character different from that related to input in which the contact point moves from an outside position to the direction indicating section 50 may be input.

Next, with reference to FIG. 18, the performance of the circumferential movement input will be described.

That is, as shown in FIG. 18(a), a character may be input through the movement of the contact point from the reference input section 30 to the direction indicating section 50c in a 3 o'clock direction, circumferential movement from the direction indicating section 50c in a 3 o'clock direction to the direction indicating section 50a in a 12 o'clock direction and contact with the direction indicating section 50a in a 12 o'clock direction.

Furthermore, as shown in FIG. 18(b), in the same way as that in FIG. 18(a), a character may be input by performing final input \textcircled{3} in a pressing fashion, rather than in a contact fashion, after performing input \textcircled{1} and \textcircled{2}.

In this case, in each of FIGS. 18(a) and 18(b), although respective characters assigned to three input operations may be input through the respective input operations, a new character may be input through the combination of the input operations. In the case where a new character is input through the combination of three input operations, different characters may be input because the final inputs \textcircled{3} of FIGS. 18(a) and 18(b) are different from each other. For example, when contact with the direction indicating section 50a in a 12 o'clock direction is performed after the inputs \textcircled{1} and \textcircled{2} have been performed, as shown in FIG. 18(a), in the case where ‘ [symbol] ’ is assigned to the input \textcircled{1} of FIG. 18 and ‘ [symbol] is assigned to the input \textcircled{2} of FIG. 18, the syllable ‘ [symbol] ’ may be displayed while ‘ [symbol] ’ is input. Furthermore, when pressing is performed on a direction indicating section in a 12 o'clock direction after inputs \textcircled{1} and \textcircled{2} have been performed, as shown in FIG. 18(b), the consonant under a vowel [symbol] ’ may be added to the syllable ‘ [symbol] while ‘ [symbol] ’ is input.

All or some of the above-described various input operations may be implemented in a single character input device.

In greater detail, as shown in FIG. 19(a), contact, pressing, inward contact movement, outward contact movement, inward pressing movement and outward pressing movement may be performed on each of the respective direction indicating sections 50a to 50h provided in the ring input section 60. Furthermore, as shown in FIG. 19(b), contact and pressing are performed on each of the respective direction indicating sections 50a to 50h provided in the ring input section 60, and inward contact movement, outward contact movement, inward pressing movement and outward pressing movement may be performed between each of the direction indicating sections 50a to 50h and the reference input section 30.

In this case, different characters may be assigned to the respective input operations, the same character may be assigned to two input operations, and the same character may be assigned to respective input operations.

Furthermore, the number of respective direction indicating sections may be various, and a larger number of characters may be input through the combination of FIGS. 19(a) and 19(b).

Meanwhile, as shown in FIGS. 20 to 22, a different character may be input depending on whether two input operations are connected through circumferential input.

That is, in FIG. 20(a), respective assigned characters are input through the movement of a pressing point to the direction indicating sections 50c in a 3 o'clock direction (\textcircled{1} in FIG. 20(a)) and the movement of the contact point from the direction indicating section 50a in a 12 o'clock direction (\textcircled{2} in FIG. 20(a)). Meanwhile, when circumferential movement is performed after input \textcircled{1} and input \textcircled{2} is immediately performed, as shown in FIG. 20(b), a character different from a character related to input \textcircled{2} in FIG. 20(a) may be input with respect to the input \textcircled{2}.

For example, in FIG. 20(a), when inputs \textcircled{1} and \textcircled{2} are sequentially performed in the case where ‘ [symbol] ’ is assigned to the input \textcircled{1} and ‘ [symbol] ’ is assigned to the input \textcircled{2}, the syllable ‘ [symbol] ’ is input. In contrast, circumferential movement is performed after input \textcircled{1} and input \textcircled{2} is immediately input, as shown in FIG. 20(b), a character assigned to the input \textcircled{2} may be modified into ‘ [symbol] ’, and thus the syllable ‘ [symbol] ’ may be input.

In a similar way, with regard to the movement of the contact point from the reference input section 30 to the direction indicating section 50b in a 1 o'clock direction (\textcircled{1} in FIG. 21(a)) and contact with the direction indicating section 50a in a 12 o'clock direction (\textcircled{2} in FIG. 21 a), shown in FIG. 21(a), if circumferential movement is included between the input \textcircled{1} and the input \textcircled{2} input, as shown in FIG. 21(b), a different character may be input with respect to the input \textcircled{2}.

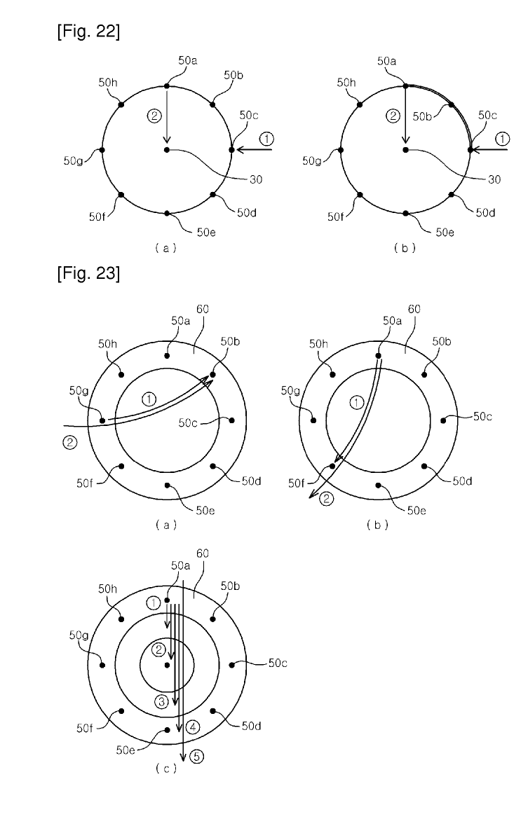

Furthermore, with regard to the movement of the contact point to the direction indicating section 50c in a 3 o'clock direction (\textcircled{1} in FIG. 22(a)) and the movement of the contact point from the direction indicating section 50a in a 12 o'clock direction to the reference input section 30 (\textcircled{2} in FIG. 22(a)), as shown in FIG. 22(a), if circumferential movement is included between the input \textcircled{1} and the input \textcircled{2}, as shown in FIG. 22(b), a different character may be input with respect to the input \textcircled{2}.

### Fifth Embodiment

Next, a fifth embodiment of the input operation of the character input device 1 according to the present invention will be described with reference to FIG. 23.

In the present embodiment, a ring input section 60 is provided, and characters are input through the input of movement from each of direction indicating sections 50a to 50h on the ring input section 60 to another direction indicating section. In this case, a character to be input is determined depending the location of an initially passed direction indicating section, such as that shown in FIG. 23(a), and the location of a finally passed direction indicating section, such as that shown in FIG. 23(b).

In greater detail, as shown in FIG. 23(a), different characters may be respectively input with respect to the movement of the contact point from a direction indicating section 50g in an 9 o'clock direction to a direction indicating section 50b in a 1 o'clock direction (\textcircled{1} in FIG. 23(a) and the movement of the contact point from a position outside the direction indicating section 50g in a 9 o'clock direction through the direction indicating section 50g to the direction indicating section 50b in 1 o'clock direction (\textcircled{2} in FIG. 23(a)). Here, the input \textcircled{1} is similar to that of the combination of FIGS. 14(e) and (b), and the input \textcircled{2} is similar to that of the combination of FIGS. 14(c) and (b).

Furthermore, as shown in FIG. 23(b), different characters may be respectively input with respect to the movement of the contact point from a direction indicating section 50a in a 12 o'clock direction to a direction indicating section 50f in a 7 o'clock direction (\textcircled{1} in FIG. 23(b)) and the movement of the contact point from the direction indicating section 50a in a 12 o'clock direction through the direction indicating section 50f in a 7 o'clock direction (\textcircled{2} in FIG. 23(b)). Here, the input \textcircled{1} is similar to that of the combination of FIGS. 14(e) and (b), and the input \textcircled{2} is similar to that of the combination of FIGS. 14(e) and (d).

Meanwhile, FIG. 23(c) is a variation of the present embodiment, in which a reference input section 30 is provided at the center of a ring input section 60. In FIG. 23(c), different characters may be respectively input with respect to the movement of the contact point from a direction indicating section 50a in a 12 o'clock direction to a position outside the ring input section 60 (\textcircled{1}), the movement of the contact point from the direction indicating section 50a in a 12 o'clock direction to the reference input section 30 (\textcircled{2}), the movement of the contact point from the direction indicating section 50a in a 12 o'clock through the reference input section 30 (\textcircled{3}), the movement of the contact point from the direction indicating section 50a in a 12 o'clock direction through the reference input section 30 to a direction indicating section 50e in a 6 o'clock direction (\textcircled{4}), and movement from a position outside the ring input section 60 through the direction indicating section 50a in a 12 o'clock direction, the reference input section 30 and a direction indicating section 50e in a 6 o'clock direction to a location outside the ring input section 60 (\textcircled{5}).

Furthermore, in FIG. 23(c), consonant 1 may be input through input \textcircled{1}, while consonant 2 may be input through input \textcircled{2}. In this case, since input \textcircled{3} is performed after the input \textcircled{2}, vowel 1 may be input along with the consonant 2 related to the input \textcircled{2}. Furthermore, since input \textcircled{4} is also performed after the input \textcircled{2} input, vowel 2 may be input along with the consonant 2 related to the input \textcircled{2}. Furthermore, since input \textcircled{5} starts with contact outside the ring input section 60, unlike the input \textcircled{1} and the input \textcircled{2} related to consonant input, consonant 3, together with vowel 3, may be input.

Here, the consonant 1, the consonant 2 and the consonant 3 and the vowel 1, the vowel 2 and the vowel 3 pertain to separable phoneme groups of characters in a specific language, they are distinguished from each other based on a specific scheme.

As described above, in the present invention, the number of characters that can be input can be considerably increased through various input operations related to the direction indicating section and the reference input section. That is, one or more of the Hangeul alphabet, the English alphabet and the Japanese Hiragana and Katakana may be arranged in the character input device. Furthermore, it is possible to provide a sufficient number of characters that can be input, assign symbols and functions to surplus characters, and enable characters, symbols and functions to be input without key switching using the character input device.

Furthermore, the number of characters that can be input using a single character input device, a keyboard function can be performed along with a mouse function, and thus the device can be conveniently used for input of Chinese characters or a game requiring the use of various keys.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1-43. (canceled)

44. A character input device comprising:
a sensing section in which an input region is provided;
a reference input section provided at the input region for identifying an input posion;
a plurality of direction indicating sections disposed equidistantly at different circumferential positions spaced apart radially from the reference input section;
direction indicators provided at one side of the reference input section or the direction indicating section for indicating the movement direction of a contact point for the input operation performed at the reference input section or the direction indicating section;
a depression sensing section provided under the sensing section for detecting the depression of the direction indicating section; and
a control unit for extracting data corresponding to each input operation, from a memory unit and inputting the extracted data, according to a contact with the direction indicating section detected by the sensing section, the depression of the direction indicating section detected by the depression sensing section, the movement of the contact point passing through the reference input section, the forward/rearward and/or leftward/rightward movement of the contact point at the direction indicating section, or the circumferential movement from the direction indicating section

45. The character input device according to claim 44, wherein consonant characters are input by the forward/rearward and/or leftward/rightward movement directions of the contact point at the each direction indicating section, and vowel characters are input by the contact with or the depression of the each direction indicating section.

46. The character input device according to claim 44, further comprising a plurality of auxiliary direction indicating sections provided between the respective direction indicating sections.

47. The character input device according to claim 46, wherein vowel characters are input by one of the contact with the each direction indicating section and the movement of the contact point passing through the reference input section, and various functional commands are input by the other.

48. The character input device according to claim 44, wherein the reference input section, the direction indicating sections and the direction indicators are respectively provided by two or more sets on the sensing section.

49. The character input device according to claim 44, wherein respective different characters are input through the contact with the direction indicating section, movement of a contact point from the reference input section to the direction indicating section, movement of a contact point from a position outside the direction indicating section to the direction indicating section, movement of a contact point from the direction indicating section to the position outside the direction indicating section, or movement of a contact point from the direction indicating section to the reference input section.

50. The character input device according to claim 44, wherein respective different characters are input through pressing on the direction indicating section, movement of a pressing point from the reference input section to the direction indicating sections, movement of a pressing point from a position outside the direction indicating section to the direction indicating section, movement of a pressing point from the direction indicating section to the position outside the direction indicating section, or movement of a pressing point from the direction indicating section to the reference input section.

51. The character input device according to claim 49, wherein the one or more of the input operations inputs a character different from that being input in combination with the one or more input operations with the circumferential movement.

52. A character input device comprising:
a sensing section provided with an input region;
a ring input section provided with a plurality of direction indicating sections, the direction indication sections being provided in the input region in a ring form and being arranged while being spaced at uniform radial intervals;
a pressing sensing section provided under the sensing section for detecting pressing on the ring input section; and
a control unit for extracting a character data from a memory unit and inputting the character data corresponding to input operations according to a contact with the direction indicating section detected by the sensing section, pressing on the direction indicating section detected by the pressing sensing section, or a movement direction of a contact point or a pressing point passing through the direction indicating section on the ring input section.

53. The character input device according to claim 52, wherein respective different characters are input through an input operation based on movement of a contact point or a pressing point from the direction indicating section through a position outside the ring input section to another direction indicating section and an input operation based on movement of a contact point or a pressing point from a position outside the ring input section through the direction indicating section and the position outside the ring input section to another direction indicating section.

54. The character input device according to claim 52, wherein respective different characters are input through an input operation based on movement of a contact point or a pressing point from the direction indicating section through a position outside the ring input section to another direction indicating section and an input operation based on movement of a contact point or a pressing point from the direction indicating section through a position outside the ring input section and another direction indicating section to a position outside the ring input section.

55. The character input device according to claim 52, wherein: a reference input section is further provided at a center of the ring input section; and respective different characters are input through an input operation based on movement of a contact point or a pressing point from the direction indicating section to a position outside the ring input section, an input operation based on movement of a contact point or a pressing point from the direction indicating section through a position outside the ring input section to the reference input section, an input operation based on movement of a contact point or a pressing point from the direction indicating section through a position outside the ring input section and the reference input section, an input operation based on movement of a contact point or a pressing point from the direction indicating section through a position outside the ring input section and the reference input section to another direction indicating section, or an input operation based on movement of a contact point or a pressing point from a position outside the ring input section through any one of the direction indicating sections, the reference input section and another direction indicating section again to a position outside the ring input section.

56. The character input device according to claim 52, wherein: the ring input section enables a circumferential contact movement input, and the control unit processes a first input and a last input as a valid input when a plurality of inputs are detected along a path during the circumferential contact movement input.

57. The character input device according to claim 56, wherein when at least two or more inputs of a contact input, an inward contact movement input, an outward contact movement input and a circumferential contact movement input to the ring input section are sequentially detected by the pressing sensing section, the control unit processes a character corresponding to each of the inputs as an input.

58. The character input device according to claim 44, wherein the reference input section comprises a reference input sensing section for sensing a contact therewith.

59. The character input device according to claim 44, wherein the input operation is performed in such a fashion that the contact point located in the direction indicating section is moved to a tangential direction of a circle having a predetermined radius from the center of the reference input section.

60. The character input device according to claim 44, wherein the control unit extracts and inputs respective different characters according to the direction indicating section which the input operation with the circumferential direction starts from and ends at, the performed direction or the performed distance of the input operation.

61. The character input device according to claim 44, in the case where the input operation is performed by the movement of the contact point, a multiple-stage input of two or more stages is performed according to a difference in the movement distance of the contact point.

62. The character input device according to claim 44, wherein the depression sensing section enables a multiple-stage input of two or more stages according to the depression strength of the contact point.

63. The character input device according to claim 50, wherein the one or more of the input operations inputs a character different from that being input in combination with the one or more input operations with the circumferential movement.
